(19) United States
(12) Patent Application Publication
(10) Pub. No.: US 2026/0204473 A1
(43) Pub. Date: Jul. 16, 2026

(54) COIL COMPONENT

(71) Applicant: TDK CORPORATION, Tokyo (JP)

(72) Inventors: Tomonaga NISHIKAWA, Tokyo (JP); Akira MOTOHASHI, Tokyo (JP); Naoaki FUJII, Tokyo (JP); Masahiro FUKUYAMA, Tokyo (JP); Hiroki NAKAGOMI, Tokyo (JP)

(73) Assignee: TDK CORPORATION, Tokyo (JP)

(21) Appl. No.: 19/441,126

(22) Filed: Jan. 6, 2026

(30) Foreign Application Priority Data
Jan. 10, 2025 (JP) 2025-004125

(51) Int. Cl. H01F 27/32; H01F 27/28; H01F 27/29

(52) U.S. Cl. CPC H01F 27/324; H01F 27/2828; H01F 27/292

(57) ABSTRACT

Disclosed herein is a coil component that includes a magnetic element body, a coil part embedded in the magnetic element body, and an insulating resin located between the magnetic element body and the coil part. The magnetic element body includes a mounting surface, an upper surface, a first side surface, and a second side surface. The coil part includes a first conductor layer, a second conductor layer, and one or more third conductor layers located between the first and second conductor layers. The first to third conductor layers are exposed on the mounting surface of the magnetic element body. The insulating resin includes first to fourth exposed parts exposed on the mounting surface, the upper surface, the first side surface, and the second side surface of the magnetic element body, respectively.

### CROSS-REFERENCE TO RELATED APPLICATION

This application claims the benefit of Japanese Patent Application No. 2025-004125, filed on January 10, 2025, the entire disclosure of which is incorporated by reference herein.

### BACKGROUND OF THE ART

### Field of the Art

The present disclosure relates to a coil component and, more particularly, to a coil component having a structure in which a coil pattern is embedded in a magnetic element body.

### Description of Related Art

JP 2021-019088A discloses a coil component having a structure in which a coil pattern is embedded in a magnetic element body.

In coil components of this type, increasing the outer diameter of the coil pattern while maintaining the size of the magnetic element body results in the formation of a thinned region in the magnetic element body, and in this portion, magnetic filler particles contained in the magnetic element body is likely to detach.

### SUMMARY

A coil component according to an aspect of the present disclosure includes: a magnetic element body having a mounting surface, an upper surface located on the opposite side of the mounting surface, and first and second side surfaces which are orthogonal to the mounting surface and the upper surface and located on mutually opposite sides; a coil part embedded in the magnetic element body and including a plurality of conductor layers stacked in the direction parallel to the mounting surface, the upper surface, and the first and second side surfaces; and an insulating resin located between the magnetic element body and the coil part. The plurality of conductor layers include a first conductor layer, a second conductor layer, and one or more third conductor layers located between the first and second conductor layers. The first conductor layer includes a first coil pattern whose outer peripheral end is exposed on the mounting surface, the exposed outer peripheral end constituting one end of the coil part, and a first terminal pattern exposed on the mounting surface. The second conductor layer includes a second coil pattern whose outer peripheral end is exposed on the mounting surface, the exposed outer peripheral end constituting the other end of the coil part, and a second terminal pattern exposed on the mounting surface. The third conductor layer includes a third coil pattern, one end of which is connected to the one end of the coil part through the first coil pattern, and the other end of which is connected to the other end of the coil part through the second coil pattern, and third and fourth terminal patterns exposed on the mounting surface. The insulating resin includes: a first exposed part exposed on the mounting surface through a region between the group consisting of the outer peripheral end of the first coil pattern, the second terminal pattern, and third terminal pattern and the group consisting of the outer peripheral end of the second coil pattern, the first terminal pattern, and the fourth terminal pattern; a second exposed part exposed on the upper surface; a third exposed part exposed on the first side surface; and a fourth exposed part exposed on the second side surface.

### BRIEF DESCRIPTION OF THE DRAWINGS

The above features and advantages of the present disclosure will be more apparent from the following description of some embodiments taken in conjunction with the accompanying drawings, in which:

FIGS. 1A and 1B are schematic perspective views illustrating the external appearance of a coil component 100 according to an embodiment of the technology described herein, as viewed from different directions;

FIG. 2 is a schematic perspective view illustrating the coil component 100 from which the terminal electrodes 121 and 122 have been removed;

FIG. 3 is a schematic cross-sectional view for explaining the structure of the conductor layer L1 in the coil component 100;

FIG. 4 is a schematic cross-sectional view for explaining the structure of the conductor layer L2 in the coil component 100;

FIG. 5 is a schematic cross-sectional view for explaining the structure of the conductor layer L3 in the coil component 100;

FIG. 6 is a schematic cross-sectional view for explaining the structure of the conductor layer L4 in the coil component 100;

FIG. 7 is a schematic cross-sectional view for explaining the structure of the conductor layer L5 in the coil component 100;

FIG. 8 is a schematic cross-sectional view for explaining the structure of the conductor layer L6 in the coil component 100;

FIG. 9 is a schematic perspective view of a coil component 100A according to a modification;

FIG. 10 is a schematic cross-sectional view for explaining the structure of the conductor layer L1 in the coil component 100A;

FIG. 11 is a schematic cross-sectional view for explaining the structure of the conductor layer L2 in the coil component 100A;

FIG. 12 is a schematic cross-sectional view for explaining the structure of the conductor layer L3 in the coil component 100A;

FIG. 13 is a schematic cross-sectional view for explaining the structure of the conductor layer L4 in the coil component 100A;

FIG. 14 is a schematic cross-sectional view for explaining the structure of the conductor layer L5 in the coil component 100A; and

FIG. 15 is a schematic cross-sectional view for explaining the structure of the conductor layer L6 in the coil component 100A.

### DETAILED DESCRIPTION OF THE EMBODIMENTS

The present disclosure describes a technology for suppressing detachment of magnetic filler particles in a coil component having a structure in which a coil pattern is embedded in a magnetic element body, even when the outer diameter of the coil pattern is increased.

Some embodiments of the present disclosure will be explained below in detail with reference to the accompanying drawings.

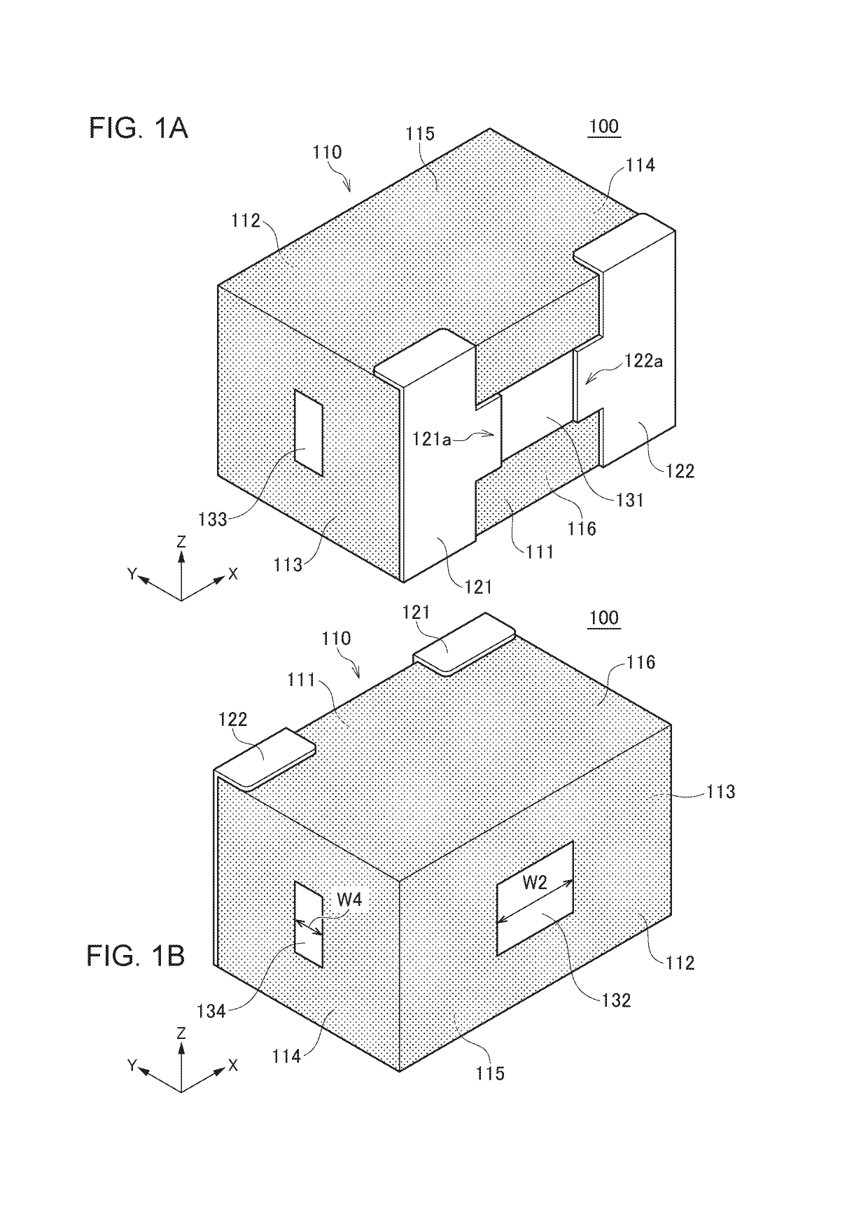

FIGS. 1A and 1B are schematic perspective views illustrating the external appearance of a coil component 100 according to an embodiment of the technology described herein, as viewed from different directions.

As illustrated in FIGS. 1A and 1B, the coil component 100 according to the present embodiment includes a magnetic element body 110 and a pair of terminal electrodes 121 and 122 provided on a mounting surface 111 of the magnetic element body 110. As described later, a coil part including conductor layers L1 to L6 is embedded in the magnetic element body 110, with one end of the coil part connected to the terminal electrode 121 and the other end connected to the terminal electrode 122.

The magnetic element body 110 may be made of a composite magnetic material obtained by binding, with binder resin, magnetic filler particles formed of a high-permeability material such as ferrite or permalloy. To increase the inductance of the coil component 100, magnetic filler particles having a large diameter are preferably used. The magnetic element body 110 has a mounting surface 111 and an upper surface 112, which together define the XZ plane and are located on mutually opposite sides; side surfaces 113 and 114, which define the YZ plane and are located on mutually opposite sides; and side surfaces 115 and 116, which define the XY plane and are located on mutually opposite sides. Accordingly, these three sets (111 and 112, 113 and 114, 115 and 116) of surfaces are orthogonal to one another.

The terminal electrode 121 is provided at an end portion of the mounting surface 111 in the negative X-direction, and the terminal electrode 122 is provided at an end portion of the mounting surface 111 in the positive X-direction. The widths of the terminal electrodes 121 and 122 in the Z-direction may be the same as the width of the mounting surface 111 in the Z-direction. The terminal electrode 121 may partially extend around to the side surfaces 115 and 116 of the magnetic element body 110 and also to the side surface 113. The terminal electrode 122 may partially extend around to the side surfaces 115 and 116 of the magnetic element body 110 and also to the side surface 114.

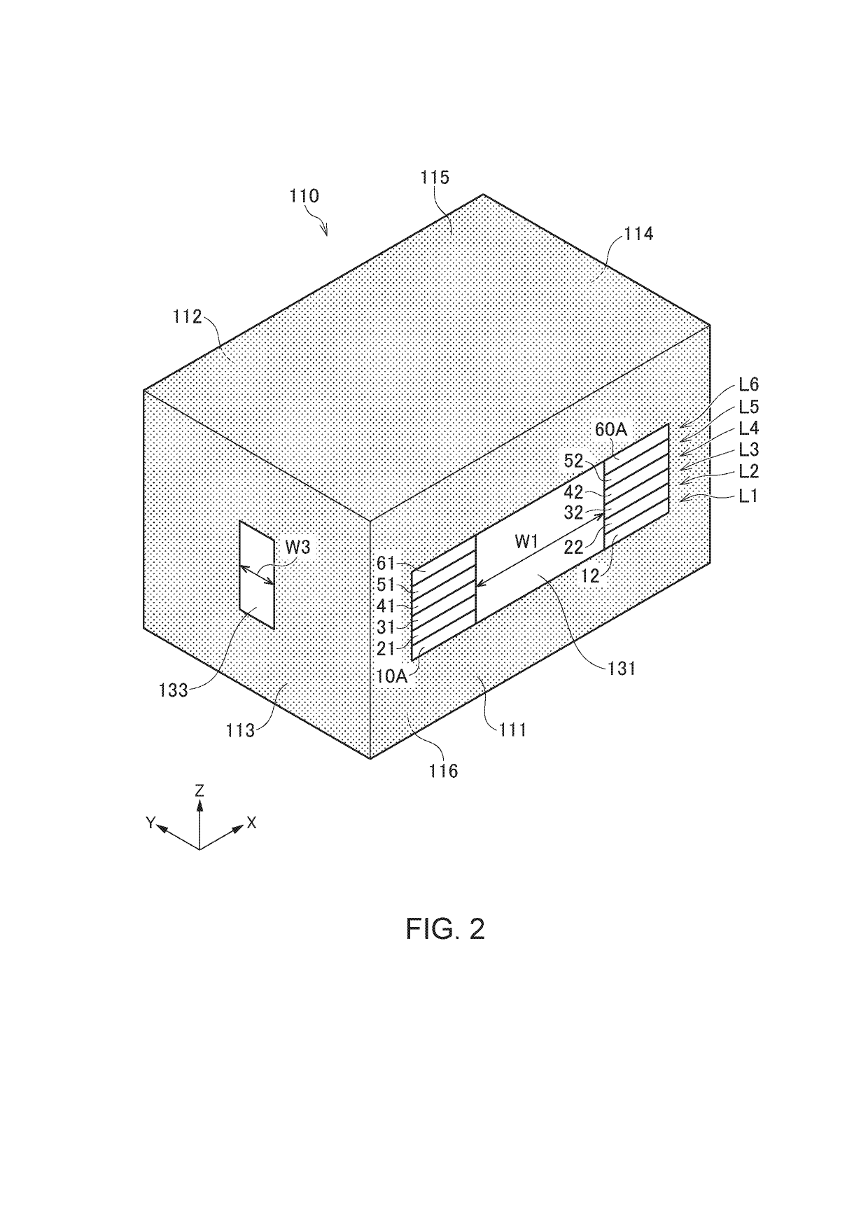

FIG. 2 is a schematic perspective view illustrating the coil component 100 from which the terminal electrodes 121 and 122 have been removed.

As illustrated in FIG. 2, an outer peripheral end 10A of a coil pattern located in the conductor layer L1, and terminal patterns 21, 31, 41, 51, and 61 respectively located in the conductor layers L2 to L6, are exposed on the mounting surface 111 of the magnetic element body 110 and are arranged in the Z-direction on the mounting surface 111. The terminal electrode 121 is provided so as to come into contact with the outer peripheral end 10A of the coil pattern and terminal patterns 21, 31, 41, 51, and 61. Further, terminal patterns 12, 22, 32, 42, and 52 respectively located in the conductor layers L1 to L5, and an outer peripheral end 60A of a coil pattern located in the conductor layer L 6 are exposed on the mounting surface 111 of the magnetic element body 110 and are arranged in the Z-direction on the mounting surface 111. The terminal electrode 122 is provided so as to come into contact with the terminal patterns 12, 22, 32, 42, and 52 and the outer peripheral end 60A of the coil pattern.

An exposed part 131 of an insulating resin is exposed on a region between the group consisting of the outer peripheral end 10A of the coil pattern and the terminal patterns 21, 31, 41, 51, and 61, and the group consisting of the terminal patterns 12, 22, 32, 42, and 52 and the outer peripheral end 60A of the coil pattern. Similarly, an exposed part 132 of the insulating resin is exposed on the upper surface 112, an exposed part 133 of the insulating resin is exposed on the side surface 113, and an exposed part 134 of the insulating resin is exposed on the side surface 114.

In the example illustrated in FIGS. 1A and 1B, the exposed part 131 is located at substantially the center of the mounting surface 111 in the X-direction. Similarly, the exposed part 132 is located at substantially the center of the upper surface 112 in the X-direction. The exposed part 133 is located at substantially the center of the side surface 113 in the Y-direction, and the exposed part 134 is located at substantially the center of the side surface 114 in the Y-direction.

As illustrated in FIG. 1A, the terminal electrodes 121 and 122 may respectively have regions 121a and 122a that cover the exposed part 131. In this case, the areas of the terminal electrodes 121 and 122 are enlarged, so that when the coil component 100 is mounted on a circuit board using solder or the like, mounting reliability is enhanced. The widths of the regions 121a and 122a in the Z-direction may be the same as the width of the exposed part 131 in the Z-direction, or may be larger than the width of the exposed part 131 in the Z-direction, such that the regions 121a and 122a partially cover the mounting surface 111 of the magnetic element body 110. In the latter case, the boundaries between the mounting surface 111 of the magnetic element body 110 and the exposed part 131 of the insulating resin are covered with the regions 121a and 122a of the terminal electrodes 121 and 122, whereby detachment of the magnetic filler particles is suppressed. Such regions 121a and 122a may be formed by allowing the terminal electrodes 121 and 122 in a paste state to flow toward the exposed part 131. The flowing widths of the terminal electrodes 121 and 122 to the exposed part 131 can be adjusted in accordance with the surface roughness of the exposed part 131; the lower the surface roughness of the exposed part 131, the farther the terminal electrodes 121 and 122 can flow. The surface roughness of the exposed part 131 may be lower than the surface roughness of the magnetic element body 110.

The coil component 100 according to the present embodiment has a configuration in which the six conductor layers L1 to L6 constituting the coil part are embedded in the magnetic element body 110. The conductor layers L1 to L6 are stacked in the Z-direction, which is parallel to the mounting surface 111.

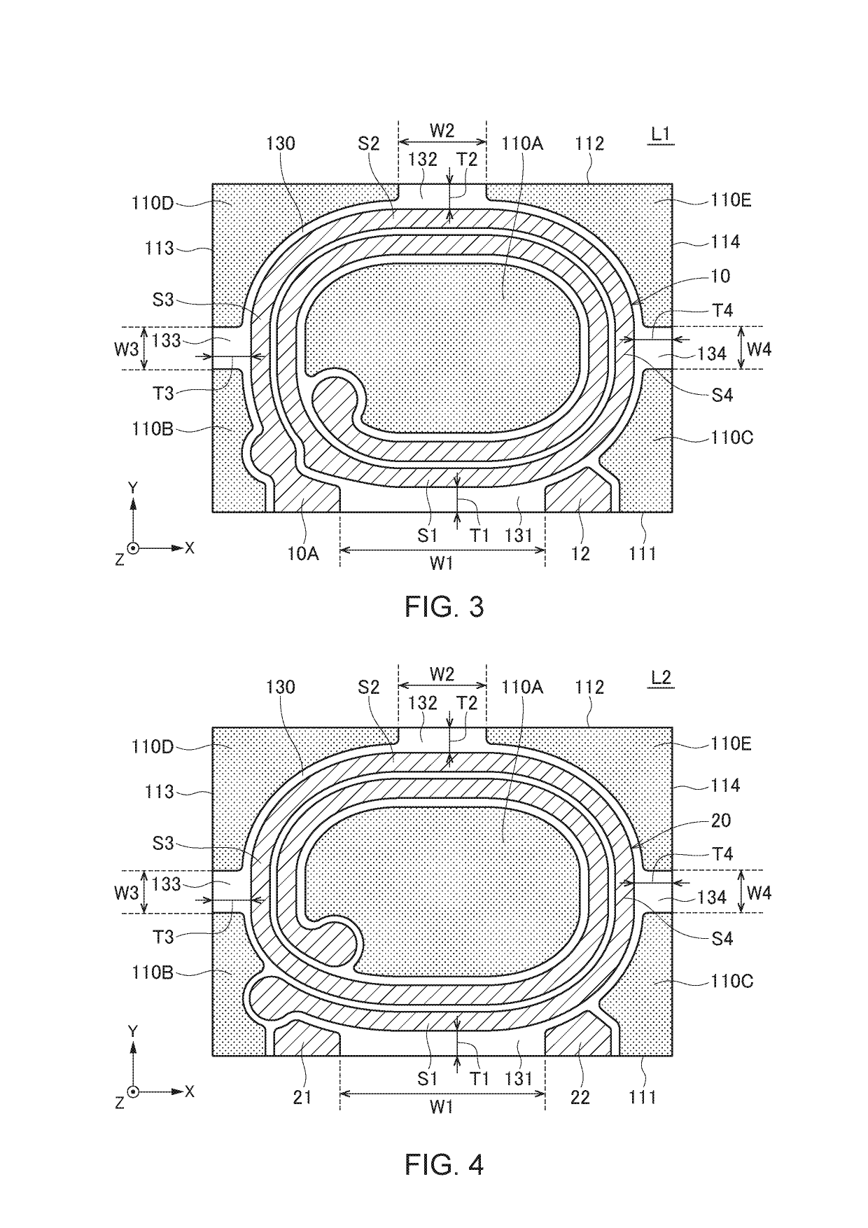

FIGS. 3 to 8 are schematic cross-sectional views for respectively explaining the structures of the conductor layers L1 to L6.

The conductor layer L1 is located at the end portion in the negative Z-direction and is formed first during manufacturing. In the example illustrated in FIG. 3, the conductor layer L1 includes a coil pattern 10 wound in about two turns and the terminal pattern 12 provided separately from the coil pattern 10 in the same plane. The outer peripheral end 10A of the coil pattern 10 and the terminal pattern 12 are exposed on the mounting surface 11 of the magnetic element body 110. An insulating resin 130 is provided between the conductor layer L1 and the magnetic element body 110, whereby contact therebetween is prevented. The insulating resin 130 may be made of a material obtained by binding, with a binder resin, inorganic filler particles formed of an insulating material such as silica.

The conductor layer L2 is the second conductor layer counted from the end portion in the negative Z-direction and is formed subsequent to the conductor layer L1 with the insulating resin 130 interposed therebetween during manufacturing. In the example illustrated in FIG. 4, the conductor layer L2 includes a coil pattern 20 wound in about two turns and the terminal patterns 21 and 22, which are provided separately from the coil pattern 20 in the same plane. The inner peripheral end of the coil pattern 20 is connected to the inner peripheral end of the coil pattern 10 located in the conductor layer L1 through a via formed in the insulating resin 130. The terminal patterns 21 and 22 are respectively connected to the outer peripheral end 10A of the coil pattern 10 and the terminal pattern 12 through vias formed in the insulating resin 130. The terminal patterns 21 and 22 are exposed on the mounting surface 111 of the magnetic element body 110. The insulating resin 130 is provided between the conductor layer L2 and the magnetic element body 110 and between the conductor layers L1 and L2, whereby the conductor layers L1 and L2 are separated from each other, and contact between the conductor layer L2 and the magnetic element body 110 is prevented.

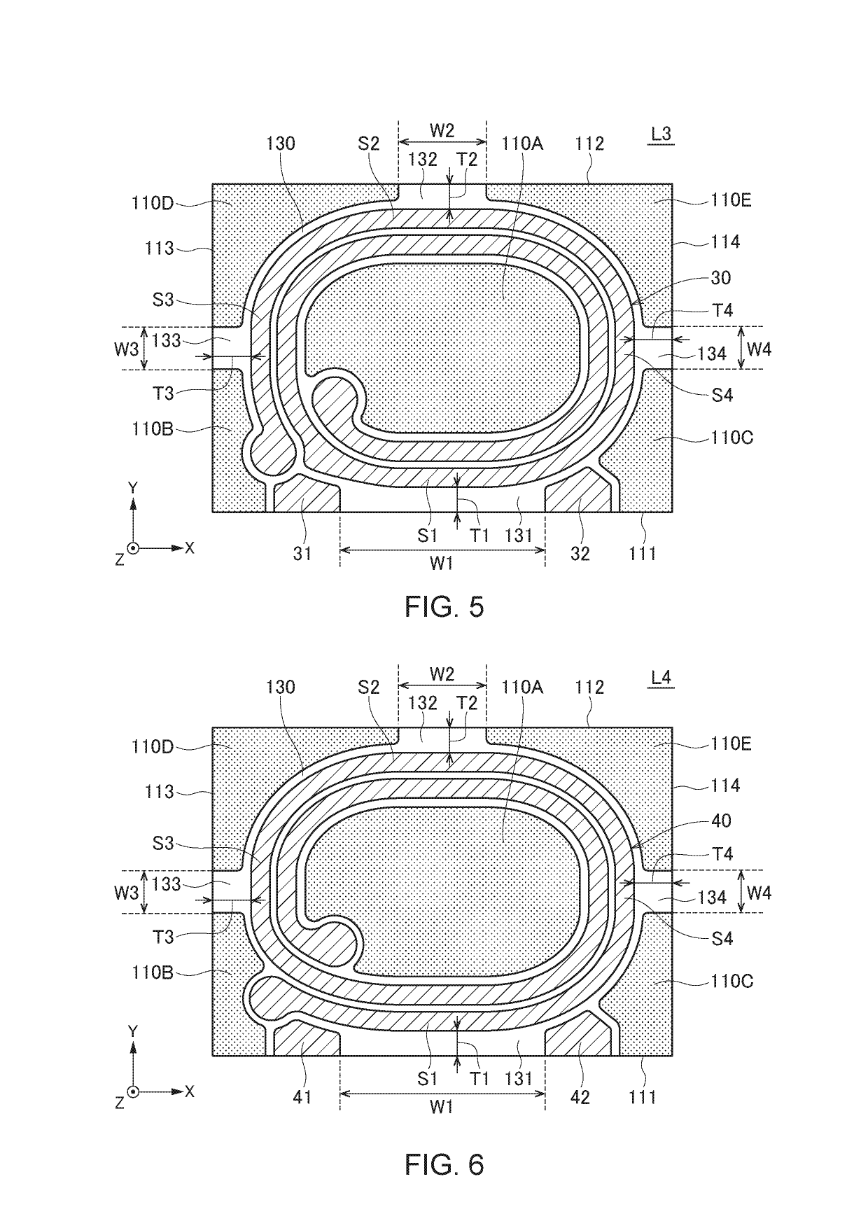

The conductor layer L3 is the third conductor layer counted from the end portion in the negative Z-direction and is formed subsequent to the conductor layer L2 with the insulating resin 130 interposed therebetween during manufacturing. In the example illustrated in FIG. 5, the conductor layer L3 includes a coil pattern 30 wound in about two turns and the terminal patterns 31 and 32, which are provided separately from the coil pattern 30 in the same plane. The outer peripheral end of the coil pattern 30 is connected to the outer peripheral end of the coil pattern 20 located in the conductor layer L2 through a via formed in the insulating resin 130. The terminal patterns 31 and 32 are respectively connected to the terminal patterns 21 and 22 in the conductor layer L2 through vias formed in the insulating resin 130. The terminal patterns 31 and 32 are exposed on the mounting surface 111 of the magnetic element body 110. The insulating resin 130 is provided between the conductor layer L3 and the magnetic element body 110 and between the conductor layers L2 and L3, whereby the conductor layers L2 and L3 are separated from each other, and contact between the conductor layer L3 and the magnetic element body 110 is prevented.

The conductor layer L4 is the fourth conductor layer counted from the end portion in the negative Z-direction and is formed subsequent to the conductor layer L3 with the insulating resin 130 interposed therebetween during manufacturing. In the example illustrated in FIG. 6, the conductor layer L4 includes a coil pattern 40 wound in about two turns and the terminal patterns 41 and 42, which are provided separately from the coil pattern 40 in the same plane. The inner peripheral end of the coil pattern 40 is connected to the inner peripheral end of the coil pattern 30 located in the conductor layer L3 through a via formed in the insulating resin 130. The terminal patterns 41 and 42 are respectively connected to the terminal patterns 31 and 32 in the conductor layer L3 through vias formed in the insulating resin 130. The terminal patterns 41 and 42 are exposed on the mounting surface 111 of the magnetic element body 110. The insulating resin 130 is provided between the conductor layer L4 and the magnetic element body 110 and between the conductor layers L3 and L4, whereby the conductor layers L3 and L4 are separated from each other, and contact between the conductor layer L4 and the magnetic element body 110 is prevented.

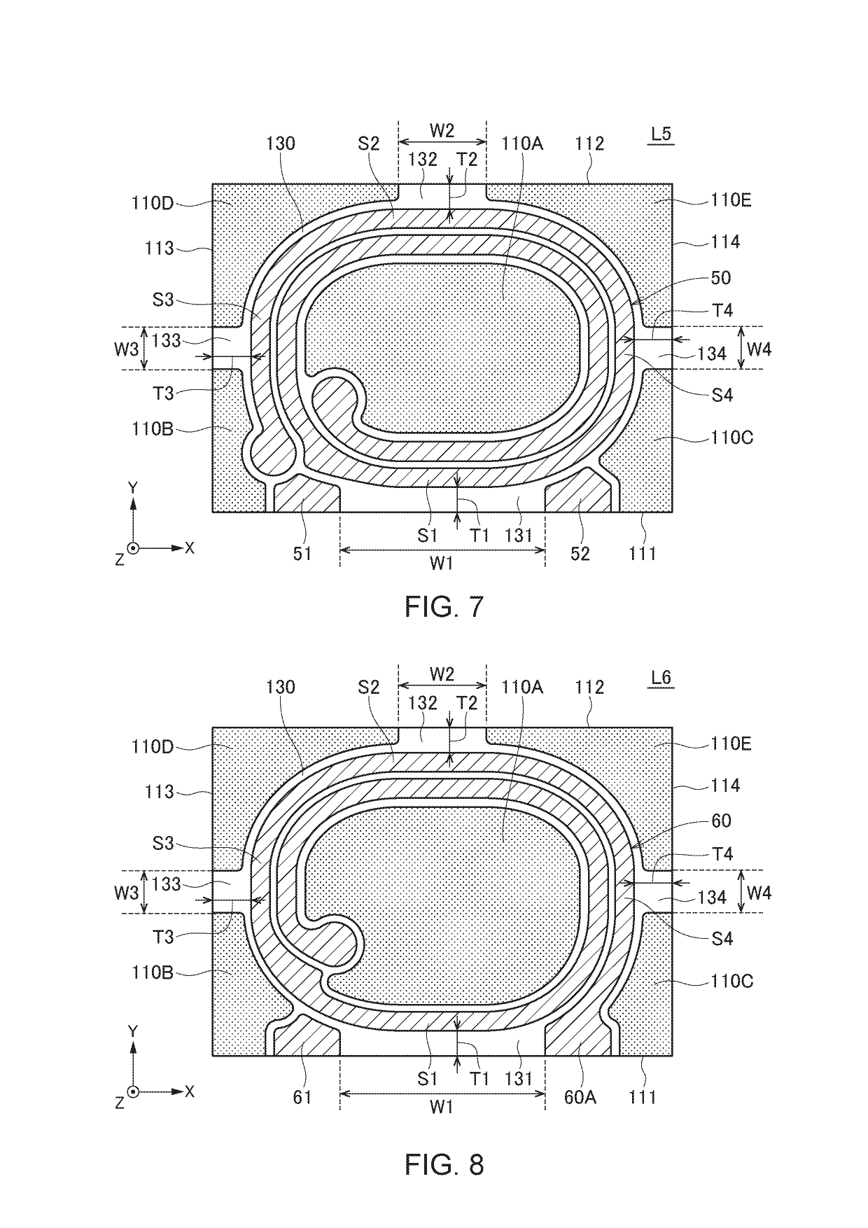

The conductor layer L5 is the fifth conductor layer counted from the end portion in the negative Z-direction and is formed subsequent to the conductor layer L4 with the insulating resin 130 interposed therebetween during manufacturing. In the example illustrated in FIG. 7, the conductor layer L5 includes a coil pattern 50 wound in about two turns and the terminal patterns 51 and 52, which are provided separately from the coil pattern 50 in the same plane. The outer peripheral end of the coil pattern 50 is connected to the outer peripheral end of the coil pattern 40 located in the conductor layer L4 through a via formed in the insulating resin 130. The terminal patterns 51 and 52 are respectively connected to the terminal patterns 41 and 42 in the conductor layer L4 through vias formed in the insulating resin 130. The terminal patterns 51 and 52 are exposed on the mounting surface 111 of the magnetic element body 110. The insulating resin 130 is provided between the conductor layer L5 and the magnetic element body 110 and between the conductor layers L4 and L5, whereby the conductor layers L4 and L5 are separated from each other, and contact between the conductor layer L5 and the magnetic element body 110 is prevented.

The conductor layer L6 is located at the end portion in the positive Z-direction and is formed subsequent to the conductor layer L5 with the insulating resin 130 interposed therebetween during manufacturing. In the example illustrated in FIG. 8, the conductor layer L6 includes a coil pattern 60 wound in about two turns and the terminal pattern 61, which is provided separately from the coil pattern 60 in the same plane. The inner peripheral end of the coil pattern 60 is connected to the inner peripheral end of the coil pattern 50 located in the conductor layer L5 through a via formed in the insulating resin 130. The terminal pattern 61 and the outer peripheral end 60A of the coil pattern 60 are respectively connected to the terminal patterns 51 and 52 in the conductor layer L5 through vias formed in the insulating resin 130. The terminal pattern 61 and the outer peripheral end 60A of the coil pattern 60 are exposed on the mounting surface 111 of the magnetic element body 110. The insulating resin 130 is provided between the conductor layer L6 and the magnetic element body 110 and between the conductor layers L5 and L6, whereby the conductor layers L5 and L6 are separated from each other, and contact between the conductor layer L6 and the magnetic element body 110 is prevented.

With the above configuration, the six coil patterns 10, 20, 30, 40, 50, and 60 are connected in series inside the magnetic element body 110 to constitute the coil part. In this coil part, the outer peripheral end 10A of the coil pattern 10 serves as one end and is connected to the terminal electrode 121, while the outer peripheral end 60A of the coil pattern 60 serves as the other end and is connected to the terminal electrode 122. For the coil patterns 20, 30, 40, and 50 located in the conductor layers L2 to L5, one end thereof is connected to the terminal electrode 121 through the coil pattern 10, while the other end thereof is connected to the terminal electrode 122 through the coil pattern 60.

As illustrated in FIGS. 3 to 8, portions of the insulating resin 130 form the exposed part 131 that is exposed on the mounting surface 111 of the magnetic element body 110, the exposed part 132 that is exposed on the upper surface 112 of the magnetic element body 110, the exposed part 133 that is exposed on the side surface 113 of the magnetic element body 110, and the exposed part 134 that is exposed on the side surface 114 of the magnetic element body 110. As a result, in each of the planes illustrated in FIGS. 3 to 8, the magnetic element body 110 is divided into five regions 110A to 110E. The region 110A is surrounded by the coil patterns 10, 20, 30, 40, 50, and 60. The region 110B constitutes the mounting surface 111 and the side surface 113 of the magnetic element body 110. The region 110C constitutes the mounting surface 111 and the side surface 114 of the magnetic element body 110. The region 110D constitutes the upper surface 112 and side surface 113 of the magnetic element body 110. The region 110E constitutes the upper surface 112 and side surface 114 of the magnetic element body 110.

In the planes illustrated in FIGS. 3 to 8, the exposed part 131 of the insulating resin 130 is located between the group consisting of the outer peripheral end 10A of the coil pattern 10 and the terminal patterns 21, 31, 41, 51, and 61, and the group consisting of the terminal patterns 12, 22, 32, 42, and 52 and the outer peripheral end 60A of the coil pattern 60. Further, in the planes illustrated in FIGS. 3 to 8, the exposed part 132 of the insulating resin 130 is located between the regions 110D and 110E of the magnetic element body 110, the exposed part 133 of the insulating resin 130 is located between the regions 110B and 110D of the magnetic element body 110, and the exposed part 134 of the insulating resin 130 is located between the regions 110C and 110E of the magnetic element body 110 .

The exposed part 131 of the insulating resin 130 includes a portion where the distance in the Y-direction between the coil patterns 10, 20, 30, 40, 50, and 60 and the mounting surface 111 of the magnetic element body 110 is minimum. The exposed part 132 of the insulating resin 130 includes a portion where the distance in the Y-direction between the coil patterns 10, 20, 30, 40, 50, and 60 and the upper surface 112 of the magnetic element body 110 is minimum. The exposed part 133 of the insulating resin 130 includes a portion where the distance in the X-direction between the coil patterns 10, 20, 30, 40, 50, and 60 and the side surface 113 of the magnetic element body 110 is minimum. The exposed part 134 of the insulating resin 130 includes a portion where the distance in the X-direction between the coil patterns 10, 20, 30, 40, 50, and 60 and the side surface 114 of the magnetic element body 110 is minimum. The above portions have a small thickness. As a result, when the magnetic element body 110 is disposed there, especially large-diameter magnetic filler particles are likely to detach. However, in the present embodiment, these portions are formed by the exposed parts 131 to 134 of the insulating resin 130. Accordingly, even when the outer diameters of the coil patterns 10, 20, 30, 40, 50, and 60 are larger, detachment of the magnetic filler particles is unlikely to occur.

Assuming that the width of the exposed part 131 in the X-direction is W1 and that of the exposed part 132 is W2, W1 may be larger than W2 (W1 > W2). On the mounting surface 111 of the magnetic element body 110, not only the outer peripheral ends 10A and 60A of the coil patterns 10 and 60 but also the terminal patterns 12, 21, 22, 31, 32, 41, 42, 51, 52, and 61 are exposed. Thus, when the magnetic element body 110 is disposed between the group consisting of the outer peripheral end 10A of the coil pattern 10 and the terminal patterns 21, 31, 41, 51, and 61, and the group consisting of the terminal patterns 12, 22, 32, 42, and 52 and the outer peripheral end 60A of the coil pattern 60, the magnetic filler particles at this portion may detach. Considering this, the X-direction width W1 of the exposed part 131 exposed on the mounting surface 111 of the magnetic element body 110 may be set sufficiently large. The exposed part 131 also serves to increase the withstand voltage between the group consisting of the outer peripheral end 10A of the coil pattern 10 and the terminal patterns 21, 31, 41, 51, and 61, and the group consisting of the terminal patterns 12, 22, 32, 42, and 52 and the outer peripheral end 60A of the coil pattern 60. On the other hand, neither the coil patterns nor the terminal patterns are exposed on the upper surface 112 of the magnetic element body 110, so that the X-direction width W2 of the exposed part 132 may be smaller than the X-direction width W1 of the exposed part 131.

Assuming that the width of the exposed part 133 in the Y-direction is W3 and that of the exposed part 134 is W4, W2 may be larger than W3 (W2 > W3) and W4 (W2 > W4). Further, W3 may be equal to W4 (W3 = W4). In the present embodiment, the coil patterns 10, 20, 30, 40, 50, and 60 have an elliptic shape whose outer diameter is larger in the X-direction than in the Y-direction. Accordingly, in each of the coil patterns, a section S3 extending along the side surface 113 and a section S4 extending along the side surface 114 have a smaller curvature than a section S1 extending along the mounting surface 111 and a section S2 extending along the upper surface 112. As a result, the X-direction length of the region in which the Y-direction distance between the coil patterns 10, 20, 30, 40, 50, and 60 and the upper surface 112 of the magnetic element body 110 is small (and magnetic filler particles are therefore likely to detach) is longer than the Y-direction length of the region in which the X-direction distance between the coil patterns 10, 20, 30, 40, 50, and 60 and the side surfaces 113 and 114 of the magnetic element body 110 is small (and magnetic filler particles are therefore likely to detach).

Considering this, the width W2 of the exposed part 132 in the X-direction may be set larger than the widths W3 and W4 of the exposed parts 133 and 134 in the Y-direction.

Assuming that the thickness of the exposed part 131 in the Y-direction is T1, the thickness of the exposed part 132 in the Y-direction is T2, the thickness of the exposed part 133 in the X-direction is T3, and the thickness of the exposed part 134 in the X-direction is T4, T1 may be smaller than T3 and T4 (T1 < T3, T1 < T4), and T2 may also be smaller than T3 and T4 (T2 < T3, T2 < T4). The thicknesses T1 to T4 decrease as the outer diameters of the coil patterns 10, 20, 30, 40, 50, and 60 increase. Parameters such as the inductance and DC superimposition characteristics of the coil component 100 generally improve as the outer diameters of the coil patterns 10, 20, 30, 40, 50, and 60 increase. However, if the outer diameters of the coil patterns 10, 20, 30, 40, 50, and 60 become too large, the volumes of the regions 110B to 110E of the magnetic element body 110 become small relative to the volume of the region 110A, which may reduce the inductance, for example. Considering this, by making the thicknesses T3 and T4 of the exposed parts 133 and 134, which have relatively small widths W3 and W4 in the Y-direction, larger than the thicknesses T1 and T2 of the exposed parts 131 and 132, which have relatively large widths W1 and W2 in the X-direction, it is possible to ensure sufficient volumes in the regions 110B to 110E of the magnetic element body 110, while also allowing an increase in the outer diameters of the coil patterns 10, 20, 30, 40, 50, and 60. As a result, parameters such as the inductance and DC superimposition characteristics of the coil component 100 can be set to appropriate values.

The exposed parts 131 to 134 may have the same height in the Z-direction.

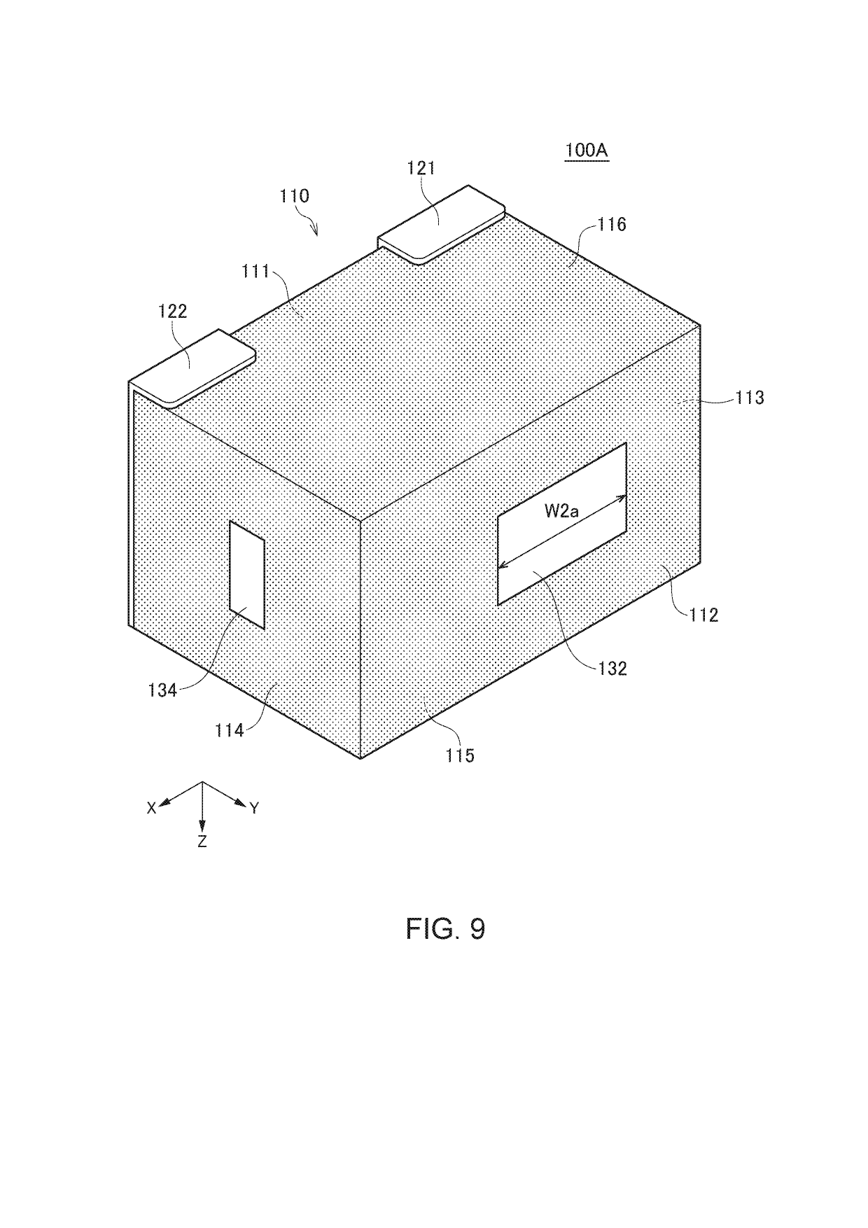

FIG. 9 is a schematic perspective view of a coil component 100A according to a modification.

As illustrated in FIG. 9, the modified coil component 100A differs from the coil component 100 according to the above embodiment in that the center of the exposed part 132 of the insulating resin 130 in the X-direction is not located at the center of the upper surface 112 of the magnetic element body 110 in the X-direction but is offset toward the negative X-direction side (side surface 113 side). Other basic configurations are the same as those of the coil component 100 according to the above embodiment, so the same reference numerals are given to the same elements, and overlapping description will be omitted.

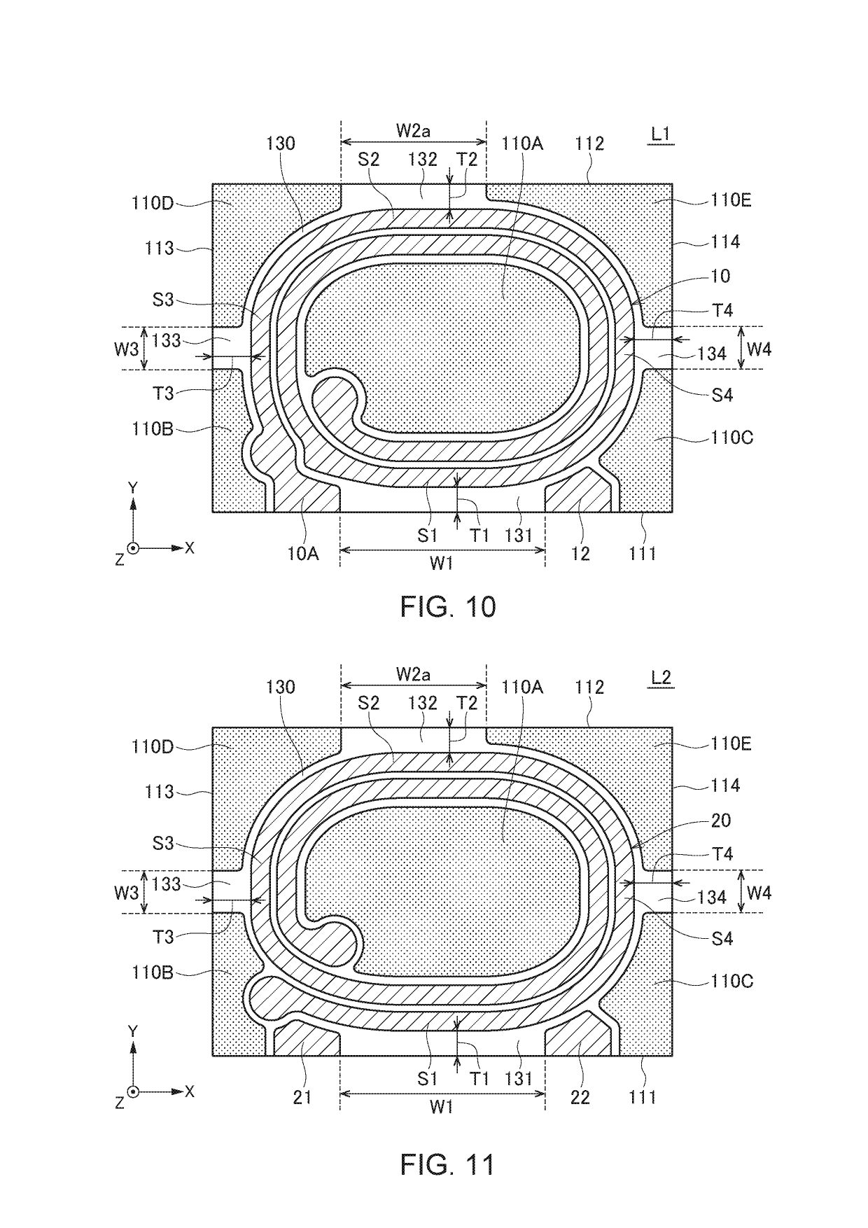

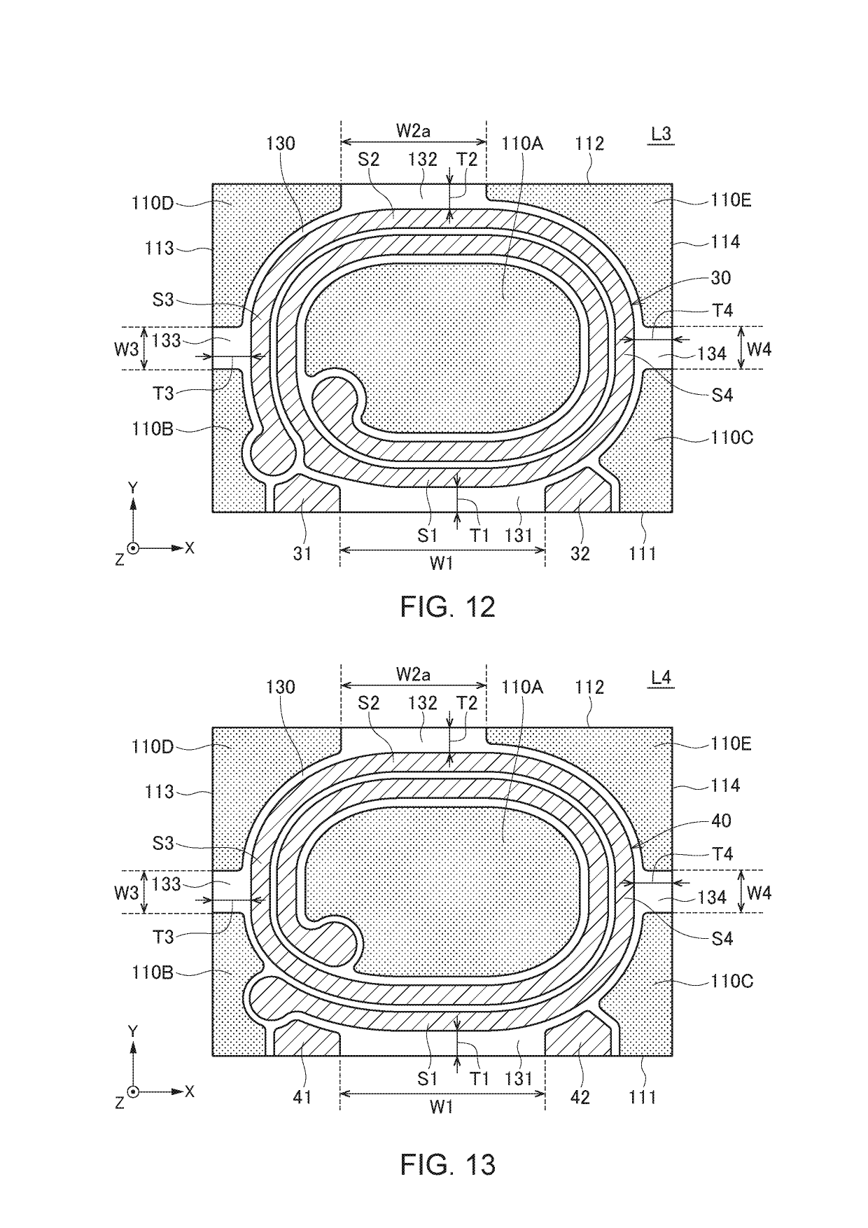

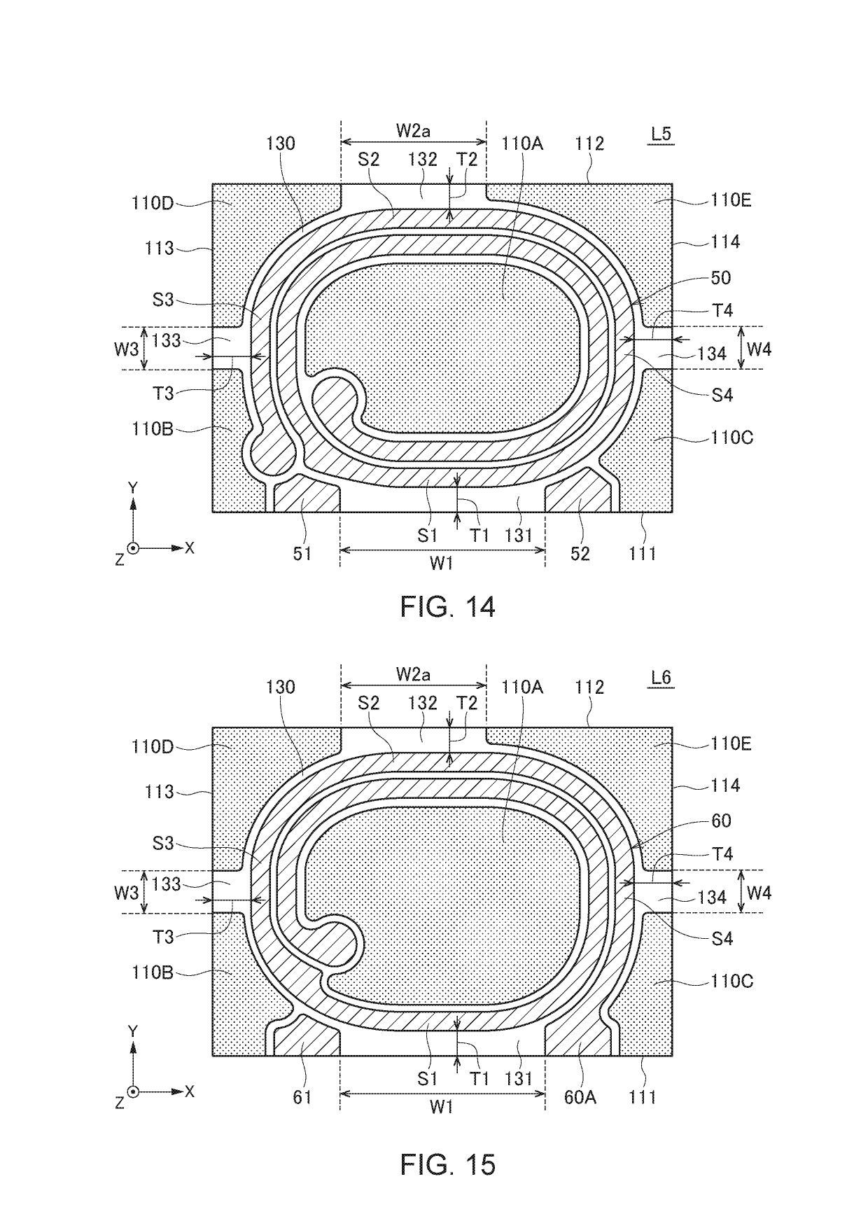

FIGS. 10 to 15 are schematic cross-sectional views for respectively explaining the structures of the conductor layers L1 to L6 in the modified coil component 100A. As illustrated in FIGS. 10 to 15, in the modified coil component 100A, the exposed part 132 of the insulating resin 130 has a width W2a in the X-direction that is larger than the width W2, and is offset toward the side surface 113 side.

In the modified coil component 100A, the offset exposed part 132 of the insulating resin 130 can be used as a direction mark.

While the preferred embodiments of the present disclosure have been described, the present invention is not limited to the above embodiments, and various modifications may be made within the scope of the present invention, and all such modifications are included in the present invention.

For example, although the coil component 100 according to the above embodiment has a configuration in which six conductor layers L1 to L6 are embedded in the magnetic element body 110, the number of stacked conductor layers embedded in the magnetic element body is not limited to this.

The technology according to the present disclosure includes the following configuration examples, but not limited thereto.

A coil component according to an aspect of the present disclosure includes: a magnetic element body having a mounting surface, an upper surface located on the opposite side of the mounting surface, and first and second side surfaces which are orthogonal to the mounting surface and the upper surface and located on mutually opposite sides; a coil part embedded in the magnetic element body and including a plurality of conductor layers stacked in the direction parallel to the mounting surface, the upper surface, and the first and second side surfaces; and an insulating resin located between the magnetic element body and the coil part. The plurality of conductor layers include a first conductor layer, a second conductor layer, and one or more third conductor layers located between the first and second conductor layers. The first conductor layer includes a first coil pattern whose outer peripheral end is exposed on the mounting surface, the exposed outer peripheral end constituting one end of the coil part, and a first terminal pattern exposed on the mounting surface. The second conductor layer includes a second coil pattern whose outer peripheral end is exposed on the mounting surface, the exposed outer peripheral end constituting the other end of the coil part, and a second terminal pattern exposed on the mounting surface. The third conductor layer includes a third coil pattern, one end of which is connected to the one end of the coil part through the first coil pattern, and the other end of which is connected to the other end of the coil part through the second coil pattern, and third and fourth terminal patterns exposed on the mounting surface. The insulating resin includes: a first exposed part exposed on the mounting surface through a region between the group consisting of the outer peripheral end of the first coil pattern, the second terminal pattern, and third terminal pattern and the group consisting of the outer peripheral end of the second coil pattern, the first terminal pattern, and the fourth terminal pattern; a second exposed part exposed on the upper surface; a third exposed part exposed on the first side surface; and a fourth exposed part exposed on the second side surface. With this configuration, even when the outer diameters of the first to third coil patterns are designed to be larger, detachment of the magnetic filler particles contained in the magnetic element body is unlikely to occur.

In the above coil component, the first exposed part may include a region where the distance between the first, second, and third coil patterns and the mounting surface is minimum, the second exposed part may include a region where the distance between the first, second, and third coil patterns and the upper surface is minimum, the third exposed part may include a region where the distance between the first, second, and third coil patterns and the first side surface is minimum, and the fourth exposed part may include a region where the distance between the first, second, and third coil patterns and the second side surface is minimum. As a result, detachment of the magnetic filler particles contained in the magnetic element body is less likely to occur.

In the above coil component, the width of the first exposed part in a first direction which is perpendicular to the first and second side surfaces may be larger than the width of the second exposed part in the first direction. This makes it possible to suppress detachment of the magnetic filler particles from the mounting surface side.

In the above coil component, each of the first, second, and third coil patterns may include a first section extending along the upper surface, a second section extending along the first side surface, and a third section extending along the second side surface, the first section may have a greater curvature than the second and third sections, and the width of the second exposed part in the first direction may be larger than the width of the third exposed part in a second direction perpendicular to the mounting surface and the upper surface and the width of the fourth exposed part in the second direction. This makes it possible to suppress detachment of the magnetic filler particles from the upper surface side at which the magnetic filler particles are more likely to detach.

In the above coil component, the thickness of the second exposed part in the second direction may be smaller than those of the third and fourth exposed parts in the first direction. This makes it possible to ensure the volume of the magnetic element body while suppressing detachment of the magnetic filler particles.

In the above coil component, the second exposed part may be offset toward the first side surface side. This allows the second exposed part to serve as a direction mark.

The above coil component may further include a first terminal electrode which is provided on the mounting surface so as to come into contact with the outer peripheral end of the first coil pattern, the second terminal pattern, and the third terminal pattern, and a second terminal electrode which is provided on the mounting surface so as to come into contact with the outer peripheral end of the second coil pattern, the first terminal pattern, and the fourth terminal pattern. This facilitates surface mounting of the coil component on a circuit board.

In the above coil component, the first and second terminal electrodes may partially cover the first exposed part. This increases the areas of the first and second terminal electrodes.

What is claimed is:

1. A coil component comprising:
a magnetic element body having a mounting surface, an upper surface located on an opposite side of the mounting surface, and first and second side surfaces which are substantially orthogonal to the mounting surface and the upper surface and located on mutually opposite sides;
a coil part embedded in the magnetic element body and including a plurality of conductor layers stacked in a direction parallel to the mounting surface, the upper surface, and the first and second side surfaces; and
an insulating resin located between the magnetic element body and the coil part,
wherein the plurality of conductor layers include a first conductor layer, a second conductor layer, and one or more third conductor layers located between the first and second conductor layers,
wherein the first conductor layer includes a first coil pattern having an outer peripheral end exposed on the mounting surface and constituting one end of the coil part, and a first terminal pattern exposed on the mounting surface,
wherein the second conductor layer includes a second coil pattern having an outer peripheral end exposed on the mounting surface and constituting other end of the coil part, and a second terminal pattern exposed on the mounting surface,
wherein the third conductor layer includes a third coil pattern having one end connected to the one end of the coil part through the first coil pattern and other end connected to the other end of the coil part through the second coil pattern, and third and fourth terminal patterns exposed on the mounting surface, and
wherein the insulating resin includes:
a first exposed part exposed on the mounting surface through a region between a group consisting of the outer peripheral end of the first coil pattern, the second terminal pattern, and third terminal pattern and a group consisting of the outer peripheral end of the second coil pattern, the first terminal pattern, and the fourth terminal pattern;
a second exposed part exposed on the upper surface;
a third exposed part exposed on the first side surface; and
a fourth exposed part exposed on the second side surface.

2. The coil component as claimed in claim 1,
wherein the first exposed part includes a region where a distance between the first, second, and third coil patterns and the mounting surface is minimum,
wherein the second exposed part includes a region where a distance between the first, second, and third coil patterns and the upper surface is minimum,
wherein the third exposed part includes a region where a distance between the first, second, and third coil patterns and the first side surface is minimum, and
wherein the fourth exposed part includes a region where a distance between the first, second, and third coil patterns and the second side surface is minimum.

3. The coil component as claimed in claim 2, wherein a width of the first exposed part in a first direction which is perpendicular to the first and second side surfaces is larger than a width of the second exposed part in the first direction.

4. The coil component as claimed in claim 3,
wherein each of the first, second, and third coil patterns includes a first section extending along the upper surface, a second section extending along the first side surface, and a third section extending along the second side surface,
wherein the first section has a greater curvature than the second and third sections, and
wherein a width of the second exposed part in the first direction is larger than a width of the third exposed part in a second direction perpendicular to the mounting surface and the upper surface and a width of the fourth exposed part in the second direction.

5. The coil component as claimed in claim 4, wherein a thickness of the second exposed part in the second direction is smaller than thicknesses of the third and fourth exposed parts in the first direction.

6. The coil component as claimed in claim 1, wherein the second exposed part is offset toward the first side surface side.

7. The coil component as claimed in claim 1, further comprising:
a first terminal electrode which is provided on the mounting surface so as to come into contact with the outer peripheral end of the first coil pattern, the second terminal pattern, and the third terminal pattern; and
a second terminal electrode which is provided on the mounting surface so as to come into contact with the outer peripheral end of the second coil pattern, the first terminal pattern, and the fourth terminal pattern.

8. The coil component as claimed in claim 7, wherein the first and second terminal electrodes partially cover the first exposed part.
